(19) United States
(12) Patent Application Publication
(10) Pub. No.: US 2018/0101819 A1
(43) Pub. Date: Apr. 12, 2018

(54) Visual Intelligence Monitoring Process

(71) Applicant: ShadowTrack 247, LLC, Fletcher, NC (US)

(72) Inventors: George P. Wheeler, JR., Arden, NC (US); Steve Taveau, Royce City, TX (US); Jeffrey W. Stingel, Asheville, NC (US)

(73) Assignee: ShdowTrack 247, LLC, Fletcher, NC (US)

(21) Appl. No.: 15/728,083

(22) Filed: Oct. 9, 2017

Related U.S. Application Data
(60) Provisional application No. 62/405,624, filed on Oct. 7, 2016.

(51) Int. Cl. G06Q 10/08

(52) U.S. Cl. CPC G06Q 10/0833; G06F 3/0481

(57) ABSTRACT

A system includes at least one tracking device and at least one corresponding data sensor for storing one or more conditions as a data point, the at least one tracking device being configured to send one or more data points over a communication network; a monitoring application server configured to electronically receive data communications from the tracking device and provide content to the user of the system based on the data communications from the tracking device, wherein the content provided is customizable based on a plurality of preset conditions; the content being displayed including a tile with one or more cues displayed therein, wherein each tile represents a corresponding one of the at least one tracking devices and each cue represents a corresponding one of the at least one corresponding data sensors; and the cues being configured to change between first and second arrangements based on the preset conditions.

### RELATED APPLICATION

This application is claims priority to and incorporates entirely by reference U.S. Provisional Patent Application Ser. No. 62/405,624 filed on Oct. 7, 2016.

### FIELD OF THE INVENTION

This invention relates to a system and process for concurrently tracking and monitoring multiple devices and shipments either through a central base, which tracks and monitors several customers' devices at one time, or by an individual customer tracking and monitoring their own devices utilizing a visual monitoring platform.

### BACKGROUND OF THE INVENTION

Having the ability to monitor GPS tracking devices and shipments on which the devices are utilized, in a manner that allows a person to determine the risks associated with the shipments is an easy process when attempting to monitor only a few devices and shipments.

However, when a person is required to monitor hundreds of devices and shipments at once, it is quite difficult to keep a full understanding of the status of the devices and shipments for which a person may be responsible. This can lead to missed threats and increased risk to the active shipments.

Presently, companies mitigate the inability to monitor several devices and shipments at one time by increasing the number of people responsible for the monitoring process or, alternatively, they utilize software that is map driven, provides single alerts or sends an electronic communication regarding any issues with the device or shipment. While these processes may provide a system for a person or a team to monitor shipments, it does not provide an entire view of an organization's supply chain by having the ability to visualize all of the devices and shipments in one easy to understand view

Accordingly, in view of the problems presented above, there exists a need for a system and process for concurrently tracking and monitoring multiple devices and shipments.

### SUMMARY OF THE INVENTION

In accordance with one form of the present invention there is provided a system including at least one tracking device and at least one corresponding data sensor for sensing one or more conditions and storing the corresponding one or more conditions as a data point, the at least one tracking device being configured to send one or more data points over a communication network; a monitoring application server configured to electronically receive data communications from the at least one tracking device and provide content to the user of the system based on the data communications from the at least one tracking device, wherein the content provided is customizable based on a plurality of preset conditions; the content being displayed including a tile with one or more cues displayed therein, wherein each tile represents a corresponding one of the at least one tracking devices and each cue represents a corresponding one of the at least one corresponding data sensors; and the cues being configured to change between first and second arrangements based on the plurality of preset conditions.

### BRIEF DESCRIPTION OF THE DRAWINGS

For a further understanding of the nature of the present invention, reference should be made to the following detailed description taken in conjunction with the accompanying screen-shots in which:

FIG. 1A is a view of a tile with a plurality of cue displays thereon, each representing different sensors associated with the respective device and shipment;

FIG. 1B is a view a tile with a plurality of cue displays thereon, each representing different sensors associated with the device and shipment;

FIG. 2A is a view of a plurality of tiles being monitored and tracked;

FIG. 2B is a view of a plurality of tiles being monitored and tracked;

FIG. 3 is a view of a selected tile and corresponding display of information associated with the device and shipment;

FIG. 4 is a view of a plurality of tiles which have been sorted and grouped to aid in monitoring the devices and shipments for the purpose of understanding the current risk status to their supply chain;

FIG. 5A is a view of the display when viewing the map view of the platform;

FIG. 5B is a view of the display when viewing the map view of the platform; and

FIG. 6 is a view of the display when viewing the calendar view of the platform.

### DETAILED DESCRIPTION OF THE PREFERRED EMBODIMENTS

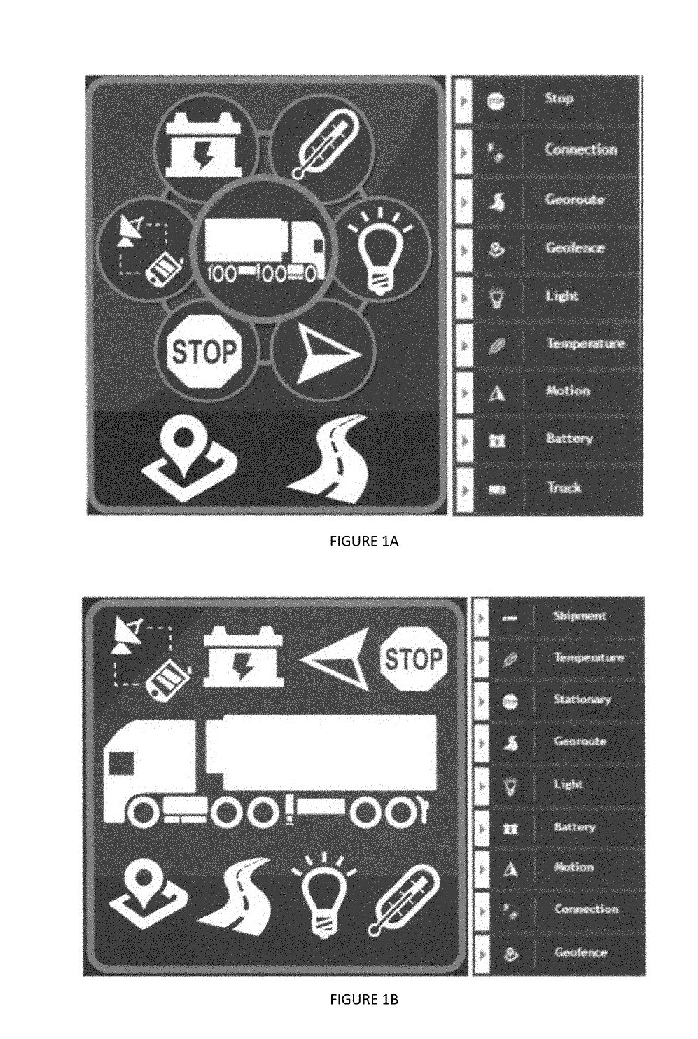

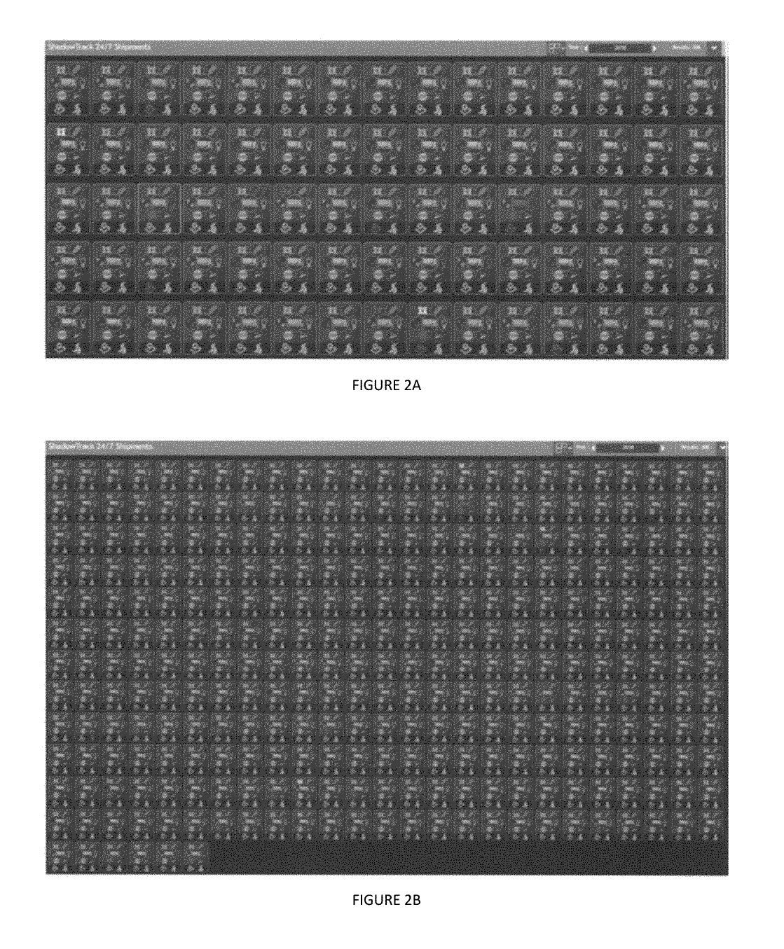

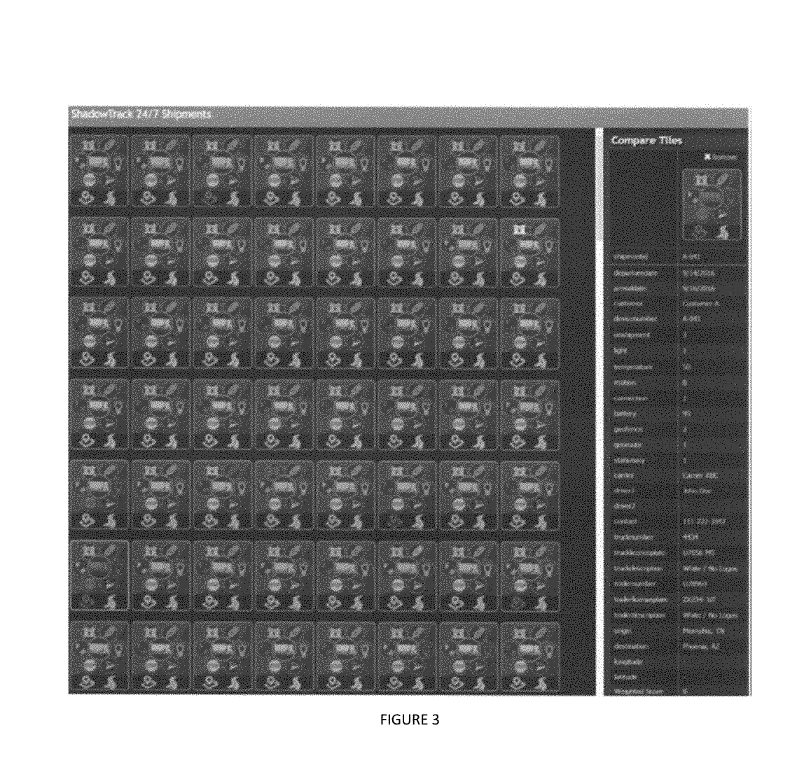

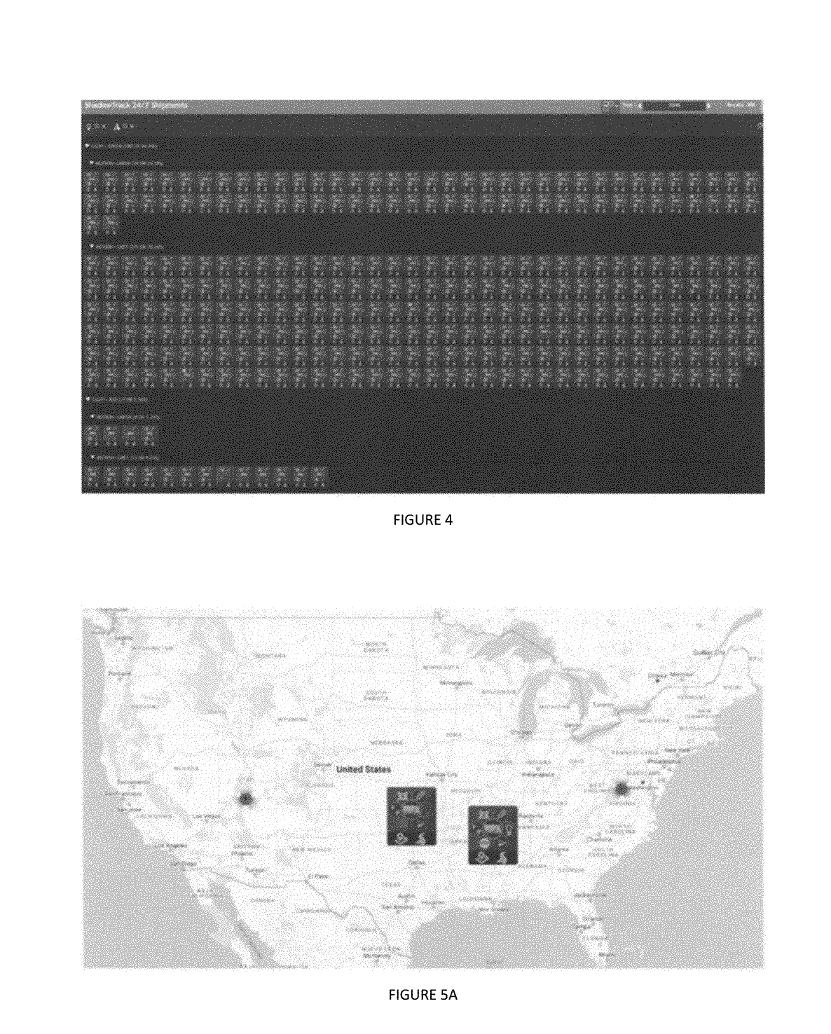

Referring to the drawings, the visual intelligence platform receives information from the tracking platform and displays information relating to the devices and corresponding shipments on an intuitive display. Referring initially to FIGS. 1A-4, data is displayed via a plurality of tiles, each representing a corresponding tracking device coupled with a shipment, and a plurality of cues, each representing a data point received by a corresponding data sensor, located within each tile.

A tracking device with one or more data sensors is activated and is displayed to a user in a tile format and any sensor displays that the device is capable of providing is displayed as a symbol (i.e., a cue) within the tile. Once the tiles and cues are established, they are assigned parameters that turn the cues a color to indicate the status of every sensor available to that device.

In one embodiment, the one or more data sensors includes a light sensor being structured and disposed for detecting the current ambient light level, which is indicated to the user by the color of the light cue on the tile based on the preset parameters.

In another embodiment, the one or more data sensors includes a temperature sensor being structured and disposed for detecting the current ambient temperature, which is indicated to the user by the color of the temperature cue on the tile based on the preset parameters.

In another embodiment, the one or more data sensors includes a humidity sensor being structured and disposed for detecting the current relative humidity, which is indicated to the user by the color of the humidity cue on the tile based on the preset parameters.

The visual intelligence platform receives data from the tracking device and displays the device data for monitoring the location and condition in a mosaic view. Since every device is displayed as a tile and each sensor is displayed as a cue, having the ability to monitor hundreds of shipments at one time by a single operator is possible. Operators respond to color changes in the cues, represented in a respective tile. The simplification of visualizing hundreds of devices and shipments in one view provides people with an immediate assessment of the risk of their supply chain.

The process of using symbols and colors to represent information also eliminates any language barriers when monitoring shipments globally. Once the symbol is understood to represent a given data input, response to that stimuli is accomplished through agreed upon protocol.

Beyond having the ability to visualize large amounts of data from the devices and shipments in a mosaic view, devices and shipments can be visualized on a map view if the location provides the latitude and longitude of the device. Visualizing certain data, such as how many shipments departed on a given date and time can be visualized in a calendar view.

Having an understanding of the current location and condition of a shipment is integral to the monitoring process and understanding of the status of a supply chain. However, in addition to displaying the device and shipment data on a map, other data can be layered on the map to indicate any external threats that may cause risk to a shipment, such as weather, traffic, or any natural or man-made incident that provides either automated or manually input data and locations.

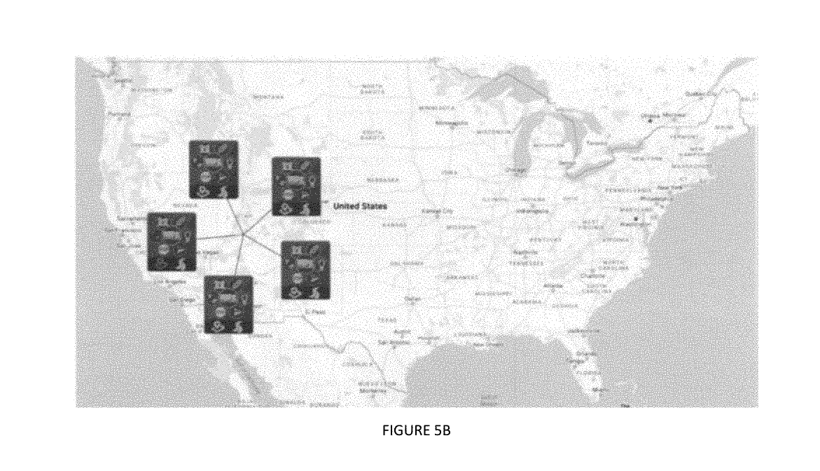

Referring to FIGS. 5A and 5B, when multiple devices are shown in close proximity, a number is shown representing the number of devices in the cluster and once that number is clicked, each device in the cluster is independently displayed.

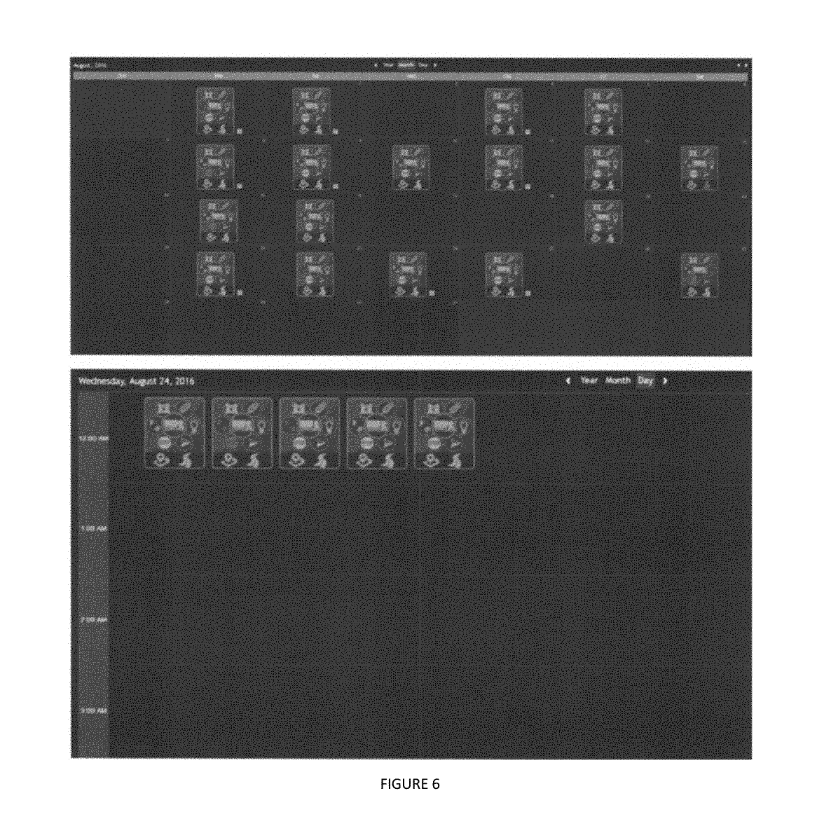

Referring to FIG. 6, the date displayed in this example would indicate the number of shipments that departed their origin in August 2016. The dates with a small icon in the right corner indicate multiple shipments departed on that date. Clicking on the date will show each shipment that departed on that date.

While the present invention has been shown and described in accordance with several preferred and practical embodiments, it is recognized that departures from the instant disclosure are contemplated within the spirit and scope of the present invention.

What is claimed is:

1. A system comprising:
at least one tracking device and at least one corresponding data sensor for sensing one or more conditions and storing the corresponding one or more conditions as a data point, said at least one tracking device being configured to send one or more data points over a communication network;
a monitoring application server configured to electronically receive data communications from said at least one tracking device and provide content to the user of the system based on the data communications from said at least one tracking device, wherein the content provided is customizable based on a plurality of preset conditions;
the content being displayed including a tile with one or more cues displayed therein, wherein each tile represents a corresponding one of said at least one tracking devices and each cue represents a corresponding one of said at least one corresponding data sensors; and
said cues being configured to change between first and second arrangements based on the plurality of preset conditions.
